(19) United States
(12) Patent Application Publication
(10) Pub. No.: US 2003/0217036 A1
(43) Pub. Date: Nov. 20, 2003

(54) Online regulatory compliance system and method for facilitating compliance

(75) Inventors: Gregory D. Haunschild, Katy, TX (US); Jon Eric Fields, Houston, TX (US)

Correspondence Address: Jo Katherine D'Ambrosio, D'Ambrosio & Associates, Suite 930, 2925 Briar Park Dr., Houston, TX, 77042, US

(73) Assignee: Argent Regulatory Services, L.L.C.

(21) Appl. No.: 10/337,681

(22) Filed: Jan. 7, 2003

Related U.S. Application Data
(63) Continuation-in-part of application No. 10/145,490, filed on May 14, 2002.

(51) Int. Cl. G06F 7/00

(52) U.S. Cl. 707/1

(57) ABSTRACT

A method and system for facilitating compliance with government regulations comprising providing a secured, interactive web site system hosted by at least one computer server. The web site system can comprise a network of computers with a server computer accessible by multiple computers at various geographic localities or a World Wide Web system having a computer server for storing and accessing compliance related data. One or more secured databases comprising governmental regulations, industry standards and company polices requiring compliance by client users are provided. Accessibility to the databases is limited to authorized users. Subject items requiring compliance are identified and the compliance requirements and necessary tasks to achieve compliance for the identified subject item are determined during the method. The results are provided to a responsible person for carrying out the required compliance tasks.

### CROSS REFERENCES TO RELATED CASES

This is a continuation in part of U.S. patent application Ser. No. 10/145,490 filed May 14, 2002, abandoned contemporaneously with the filing of this application.

### FIELD OF INVENTION

The present invention relates to a system for online regulatory compliance and a method for facilitating regulatory compliance. Particularly, the invention is directed to a web-based system for compliance with rules and regulations for industries subject to requirements of federal, state and local agencies, industry association standards and company policies.

### BACKGROUND

A myriad of rules and regulations apply to most businesses, especially those businesses and industries that affect the environment or public safety. These many rules emanate from government organizations, federal, state and local governments, industry organizations such as the American Petroleum Institute as well as a company's own policies and procedures. Automated systems of integrated computer programs for facilitating compliance with government rules and regulations are available for various government and industry organizations. Generally, pertinent references in this field relate to one of three categories: 1) systems for managing compliance with regulatory entities and/or equipment, 2) systems and methods for determining compliance with government regulations for chemical products and 3) tracking systems to determine compliance requirements for hazardous materials as part of an overall management system.

In U.S. Pat. No. 6,292,806, Sandifer discloses a computer based maintenance and repair information system for equipment subject to regulatory compliance, specifically for aircraft. The technical database comprises electronically stored publications and maintenance information for aircraft and components. The status of compliance with Airworthiness Directives and manufacturer service information is maintained for each component, allowing users to determine whether or not an aircraft is in compliance with airworthiness regulations. In the '806 patent, the maintenance and repair information may be on different CD-ROM discs and there is no electronic commingling of publications, see Col. 22, lines 5-14. Each publication must be individually searched for data regarding a specific component. See Col. 31, lines, 44-60.

The next group of disclosed patents relate to systems for compliance of chemical products. Petke et al. in U.S. Pat. No. 6,163,732 disclose a system, method and computer program for determining compliance of chemical products to governmental regulations. The chemical composition present in the chemical product to be manufactured is ascertained and compared to a stored set of government regulatory standards related to the chemical composition so that compliance can be determined. The regulatory databases are maintained and updated. The chemical composition is determined from manufacturing bills of materials. In U.S. Pat. No. 6,097,995 to Tipton et al., a hazardous materials and waste reduction management system is disclosed. The chemical management system includes a chemical inventory control system allowing a user to manage chemicals from a central station, to allow for the tracking of individual chemical containers throughout its life and an international chemical compatibility system with a compliance/education design to create compliance/education files for any country in the world. The system includes international hazardous material compatibility data stored on a computer for multi-tier compliance/education design data for creating files in any foreign language. The compliance data for chemicals is printed onto labels as well as compliance data for related safety equipment. The data represents a comparison of sampled data from an item of safety equipment compared to a set of standard criteria for performance of the item.

Wiitala et al., U.S. Pat. No. 6,122,622 disclose a computer aided system for compliance with chemical control laws. The system comprises a means for storing compliance information for substances, based on substance control laws of different jurisdictions having varying requirements and means for processing and program instructions to determine the compliance status for a product, based on the compliance information. This system is limited to chemical control law compliance.

None of the above-referenced patents discuss or resolve the problem of easy access to all rules, regulations and recommended procedures affecting a single item, such as a plant, site or piece of equipment, that emanate from a multitude of regulatory entities including state and federal agencies, industry associations and even a company's own policies and procedures directly relating to a facility site and its operations.

### SUMMARY

This invention relates to an innovative system for tracking and complying with a multitude of rules and regulations emanating from state and federal agencies, industry standards and watchdog organizations as well as from a company's own polices and procedures.

The regulatory compliance system of this invention is comprehensive in that it compiles substantially all compliance rules and regulations for subject items within a facility, the subject items including facility sites, equipment, materials and activities that may be regulated. Advantageously, the system comprises a series of software systems and programs to enable the user to identify a subject item, a gas compressor engine for example, and track substantially all government rules, regulations, industry standards and company polices and procedures affecting that subject item to ascertain the required compliance, the required tasks necessary to be in compliance and the due date for the tasks. Preferably, the compliance rules and regulations are kept evergreen by periodic updating.

One preferred embodiment of the method for regulatory compliance of this invention comprises providing a system for facilitating compliance on a secured interactive web site. The web site is accessible to multiple computers via network connectivity, a LAN (Local Area Network) system or WAN (Wide Area Network) system, for example. The system comprises compliance information data including subject items subject to compliance and required compliance rules and regulations as well as compliance tasks that must be performed to be in compliance. Subject items are facility sites, equipment, materials and activities subject to regulatory compliance. In this preferred method, the compliance requirements, including substantially all applicable rules and regulations and tasks are determined for identified subject items.

Preferably, the compliance data comprises compliance requirements data emanating from one or more laws, statutory codes, government rules and regulations, permit requirements, government standards, industry standards, rules and procedures, company procedures and guidelines, procedures and guidelines of one or more regulatory authorities or combinations thereof. The one or more regulatory authorities comprise government legislatures, government agencies, industry associations and company organizations. Accessibility can be limited to authorized users. Advantageously, the method and system of this invention works towards maintaining compliance with the various regulatory agencies by determining substantially all the rules, regulations and tasks emanating from the various agencies that are applicable to an identified subject item.

Preferably, the web site summarizes and explains the rules and regulations for the equipment and facilities, identifies a designated company person responsible for carrying out the compliance and determines the frequency of compliance tasks. The system can have a trigger program to notify responsible persons of upcoming compliance tasks and due dates for those tasks.

In another preferred embodiment of a method for facilitating compliance, the method provides a system for facilitating compliance on a secured, interactive web site that is accessible to multiple computers via a network. The method comprises providing one or more databases, preferably relational databases, for storing company data, compliance data and subject items. Preferably, access to these databases is limited to authorized users. The authorized user can be the owner of the method and software system or a client of the owner. The method comprises the step of providing one or more relational databases comprising compliance data and subject items, the compliance data comprising compliance requirements, compliance tasks to satisfy compliance requirements and due dates for tasks. Preferably, the subject items comprise facility sites, equipment, materials and activities applicable to companies. In one step of this method, a user inputs data to identify a company client including its one or more company facilities. The system then guides the user to identify substantially each subject item located at the one or more company facilities. Alternatively, the user can identify client-specific subject items, for example a specific facility site, piece of equipment, or activity that is subject to compliance to determine the compliance requirements just for that subject item. During the method of the present invention, the compliance data is applied to identified subject items to determine substantially each compliance requirement and task as well as the compliance date for the identified task, that is applicable for the identified subject items. In one preferred method, the step of applying the compliance data to identified subject items is performed by a computer processor. Alternatively, the owner or system maintenance administrator can determine compliance requirements, tasks and due dates by manually applying the rules. Reports, such as compliance reports or checklists can be generated by a report function. The responsible person for carrying out the compliance or task required is identified and then notified. The system and method of this invention then notifies each responsible person of substantially each required compliance task and compliance date. Subsequent reminders are generated until the task is completed.

In another preferred embodiment, the compliance data comprises recommended tasks for compliance and compliance triggers for performing such tasks. During the method of this invention, the step of applying the compliance data further comprises determining the compliance requirements for identified subject items as triggered by the compliance triggers. For example, a trigger can comprise a due date for a specific task. During this step, the compliance rules and regulations, required tasks and due dates as triggered are determined by the system of this invention and then transmitted to persons responsible for carrying out compliance. The compliance requirements and tasks are transmitted to responsible persons by report generators that generate one or more reports. Preferably, the reports comprise one or more checklists, compliance tables, equipment query reports, site information reports, equipment lists, inventory reports or combinations thereof. The compliance requirement data is transmitted to a responsible person carrying out compliance tasks by reminders, the reminders comprising email, fax or telephone communications.

In the present invention, the system for facilitating compliance also comprises one or more interactive functions, for example a query, sort and find function for determining compliance data applicable to identified subject items. One preferred method comprises using the query, sort and find function to determine the compliance rules and regulations for identified subject items. Once the compliance rules and regulations for a specific subject item are determined, a reporting function can generate applicable reports to notify responsible persons of the compliance requirements. A reminder function can be incorporated into the system to remind responsible persons of compliance tasks required for specific subject items. In one preferred method, a preset tickler system can automatically notify one or more responsible persons of critical due dates for compliance tasks after the reports are generated.

One innovative aspect of this invention comprises a compliance system for facilitating regulatory compliance that is located on a secured, interactive web site hosted by a server. The web site is accessible to multiple computers via network connectivity. The web site maintains a data structure that comprises one or more databases with compliance data and subject items. The system further comprises one or more secured, interface means that allow authorized users to identify specific subject items located on the databases. Preferably, the compliance system further comprises a database engine with query, sort and find software, for accessing the one or more databases to generate compliance requirements. In one preferred embodiment, the compliance system has one or more preset tickler systems that provide compliance requirement data for specific subject items to responsible parties according to due dates. Subject items can comprise facility sites, equipment, materials and activities subject to compliance and identified by the user.

One preferred system comprises report generators for producing reports related to the compliance requirements. The reports are based on data generated by the database engine and can include one or more checklists, compliance tables, equipment query reports, materials report, site information reports, equipment lists, inventory reports and combinations thereof. In one aspect, the checklist can comprise substantially each subject item within the facility, one or more compliance tasks required for the subject item and a verification signature requirement for the responsible person.

In one preferred compliance method for facilitating compliance on a secured, interactive web site, the web site is accessible to multiple computers via network connectivity. Authorized users have access to compliance data and subject items subject to compliance, such as weather data required to comply with storm water sampling regulations, The system notifies users of a specified chance of rain fall and notification of actual rainfall. Notification can be automated by a computer program or accomplished manually.

The compliance method further comprises a checklist of compliance requirement tasks to be ticked off upon completion of each task required for compliance according to the compliance data. The compliance method uses a software program for automatically providing email reminders of compliance requirements and tasks to a responsible person along a management hierarchy chain of command until the task is ticked off on the checklist.

One preferred compliance system for facilitating compliance of this invention is located on a secured, interactive web site hosted by a server that enables an authorized user to determine applicable compliance data and tasks. The compliance system can also provide a means for notifying the user of the compliance requirements and tasks required for compliance, and a checklist for ticking off completed tasks required for compliance. The compliance data includes compliance requirements emanating from one or more laws, statutory codes, government rules and regulations, permit requirements, government standards, industry standards, rules and procedures, company procedures and guidelines, procedures and guidelines of one or more regulatory authorities, for example government legislatures, government agencies, industry associations, and company organizations, or combinations thereof. The compliance system provides a means of notifying a responsible user selected from a management hierarchy list of potential non-compliance. The notification is automated by a computer or through a manual input program.

One preferred compliance system, according to this invention, comprises a data structure. The data structure can comprise compliance data, a summary of compliance rules and tasks required for compliance as well as hyperlinks to a government regulatory database comprising full text of compliance rules and required tasks. Additionally the system comprises a software program that provides a means for alerting an authorized user through an automated e-mail system to update the rules and tasks. The program can also compare the summary of compliance rules and tasks to the government regulatory database. Preferably, one or more secured, interactive web pages are located on the web site that enable users to determine updated compliance data, rules and required tasks.

In another preferred compliance system, a web site is hosted by a server that is accessible by multiple computers. A data structure comprises compliance data, a summary of compliance rules and tasks required for compliance, one or more secured, interactive web pages located on the web site that are accessible to authorized users. Preferably, the system further comprises a software program for responding to an unscheduled event requiring one or more compliance tasks. The software program comprises compliance data for tracking and reporting the unscheduled event.

Another preferred method of this invention is useful for facilitating compliance with environmental rules and regulations. Preferably, this system for facilitating compliance is accessible on a secured, interactive web site. The web site is accessible to multiple computers via network connectivity. The system comprises compliance data including environmental compliance rules and regulations, required compliance tasks and subject items subject to environmental compliance, and determination of the environmental compliance rules and regulations and tasks applicable to specific subject items. Access to the system is limited to authorized users.

The system and method of this invention can be used by various organizations and companies that must comply with environmental rules and regulations or with any other government regulations, industry standards or recommended procedures or company in-house policies. For example, the online regulatory compliance system and method can be used for online environmental and safety compliance for petrochemical plants, automobile manufacturers, and auto repair shops, within construction businesses, education facilities, food processing and any other commercial facility requiring compliance with government regulations.

### BRIEF DESCRIPTION OF DRAWINGS

FIG. 1 is a flow chart of one embodiment of the method of this invention.

FIG. 2 is a schematic illustrating one system of this invention.

FIGS. 3-31 are print outs of web pages according to one embodiment of the method and system of this invention.

### DETAILED DESCRIPTION OF THE PREFERRED EMBODIMENTS

This invention relates to a web-based system and method for facilitating regulatory compliance for companies and organizations that must comply with government regulations, industry standards and recommended procedures as well as a company's own policies and procedures for its facilities. Advantageously, each client company or user organization using the system and method of this invention can have a secured location on a web site that is accessible only to authorized persons. The web site can be accessible to multiple computers via a local area network, LAN, site or a wide area network, WAN, the World Wide Web, for example. In the practice of this invention, an individualized, evergreen compliance system for each facility, its equipment and activities, is developed and periodically updated according to new rules and regulations that may issue. Advantageously, the method and system of this invention sends out automatic reminders to responsible persons of the tasks and due dates required for compliance.

One preferred method for facilitating regulatory compliance comprises providing a secured, interactive web site in communication with a computer network, LAN or WAN network connectivity. Referring to FIG. 3, the web site is accessible to multiple computer processors on a secured basis, namely, only authorized users have access. When accessing the website 210, an authorized user must log in with some type of pass code such as a password. Security authentication and clearance is justified by the log in identification and pass code or other pass word/code authentication methods. The interactive website, in this preferred embodiment, is an addressable network site that receives, stores, and processes data. One or more computer servers may be used for hosting the website.

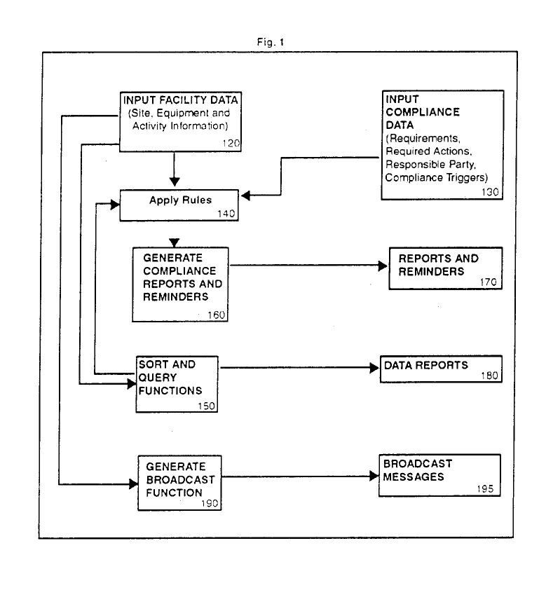

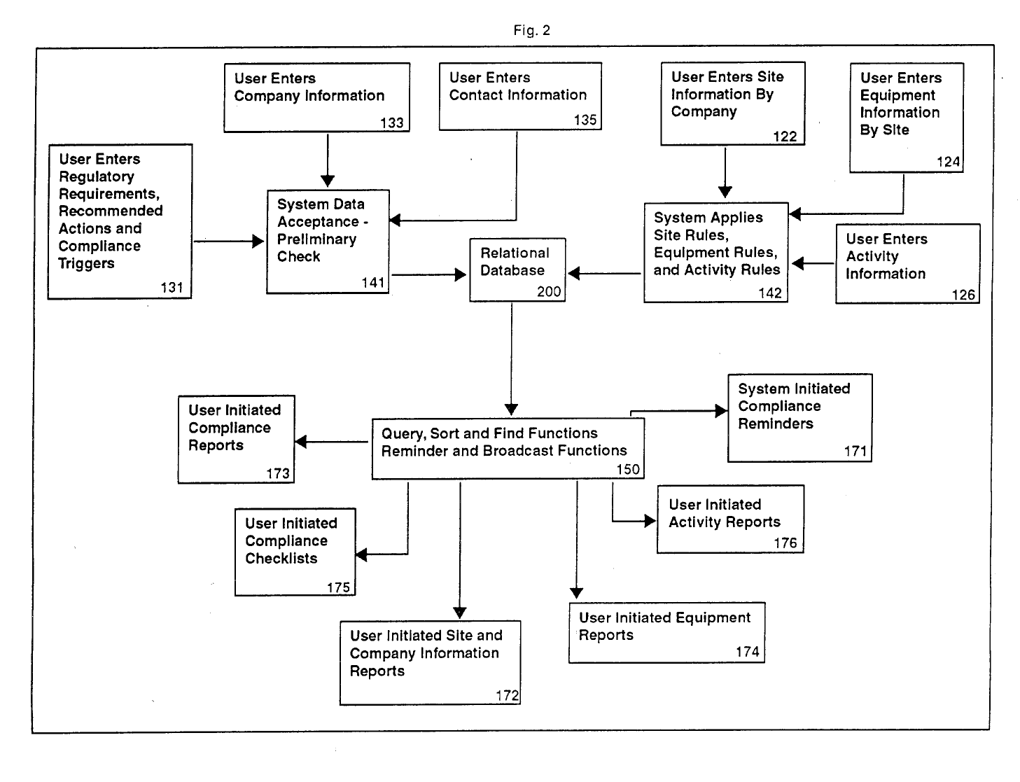

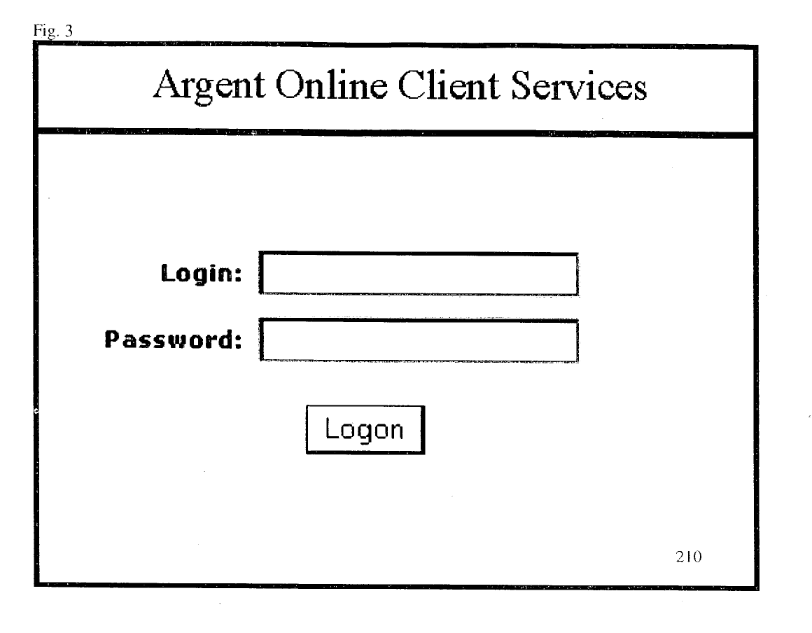

Referring to FIGS. 1 and 2, the method of this invention provides one or more databases 200, preferably relational databases, comprising compliance data, including compliance rules and regulations, subject items subject to compliance, equipment for example, and tasks required for the subject items such as inspection of a piece of equipment. The databases can be relational databases 200. Accessibility to the one or more databases is limited to authorized users. The login page in this preferred system requires a password on the access page to the software system 210. An authorized user can be the owner (Applicant) of the method and system of this invention and its employees or a representative of a client of the owner. An authorized user, usually the owner or its employee, a software maintenance administrator, inputs compliance data including regulatory requirements, recommended actions and compliance triggers 130, 131.

The regulatory compliance data 130, 131 is input into the system's one or more databases 200. The compliance data comprises compliance requirements emanating from one or more laws, statutory codes, government rules and regulations, permit requirements, government standards, industry standards, rules and procedures, the procedures, standards and guidelines of one or more regulatory authorities 130, 131. These regulatory authorities comprise government legislatures, government agencies, industry associations such as the API in the petrochemical industry, as well as companies that mandate compliance with in-house policies and procedures. The regulatory compliance data 130, 131 can further comprise recommended compliance tasks to satisfy compliance requirements and due dates for tasks for compliance. Certain compliance triggers are available to alert users to a required task and its due date, updating permits for example. Because new rules and regulations emanate frequently from the government and organizational entities, the database is preferably updated periodically so that the system is evergreen.

Preferably, the one or more databases within this regulatory compliance system further comprise subject item data. The subject item data 122, 124, 126 are also input into the one or more databases 200. These subject items can comprise facility sites 122, equipment and materials 124 and activities 126 requiring compliance. The data can be comprehensive to include substantially all equipment that can possibly be used at a particular facility such as a petrochemical plant, as well as the facility site itself (building requirements), materials used or produced and activities that may be regulated, atmospheric emissions, fuel burning and disposal of hazardous wastes for example.

Client company or organization information data 133 is also input into the one or more databases 200. This information can include geographic location, employee information, employee organizational charts, responsible persons for carrying out compliance for specific subject items 135, and contact information, addresses, phone numbers, email addresses and other information necessary to keep a company informed regarding timely compliance with rules and regulations. A system data preliminary check 141 can be performed by the software to determine completeness of information and data entered.

When an authorized user from a client company or organization accesses the web site, (s)he encounters a login page requiring authorization information such as a user name and password. In some instances, a company can authorize a third party auditor (government auditors, for example) to use the method and system of this invention to perform regulatory audits. Referring to FIG. 3, upon request for use of the compliance system, the interactive website software is programmed to initially authenticate the user by requesting and receiving authorization information such as client identification, passwords 210, or other means of identification from the requesting user. Sophisticated methods of securing access to the website, or means for authenticating can be employed, bodyscan coding, for example, is well know in the art. Bodyscan coding uses the client's eye, finger or hand prints to identify the service provider as an authorized user. One embodiment of the method and system of this invention is secured by using a combination of the operating system's built-in authentication methods and database security. For distribution over the Internet, it will be best served by the use of secure sockets layer (SSL) protocol. A secure certificate can be registered.

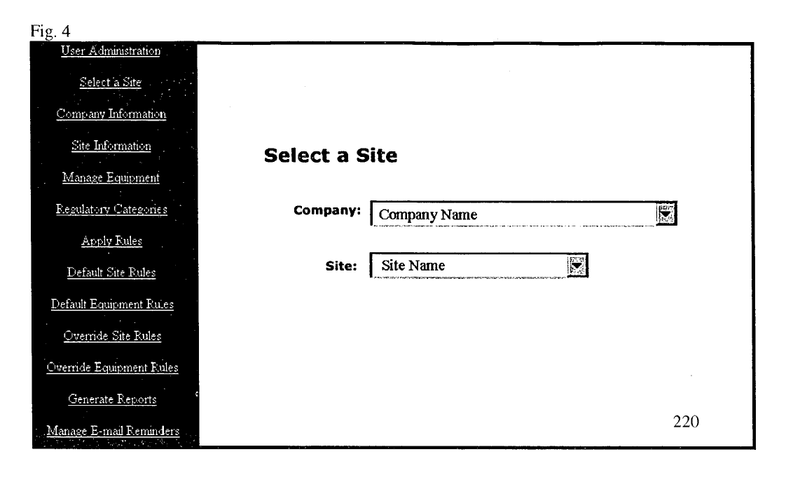

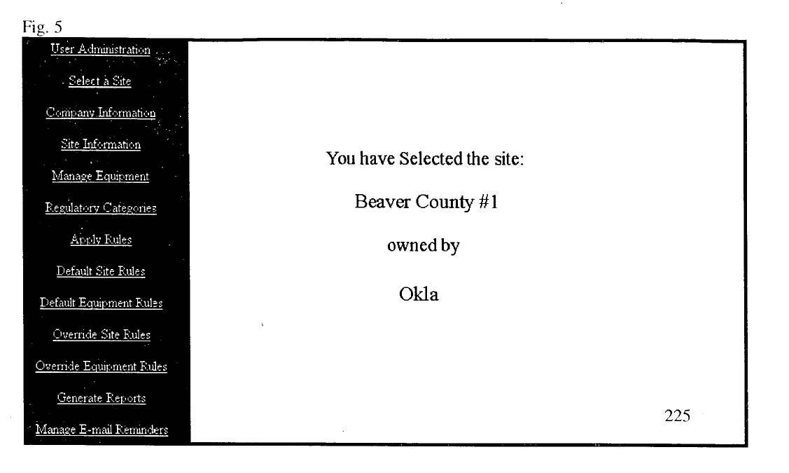

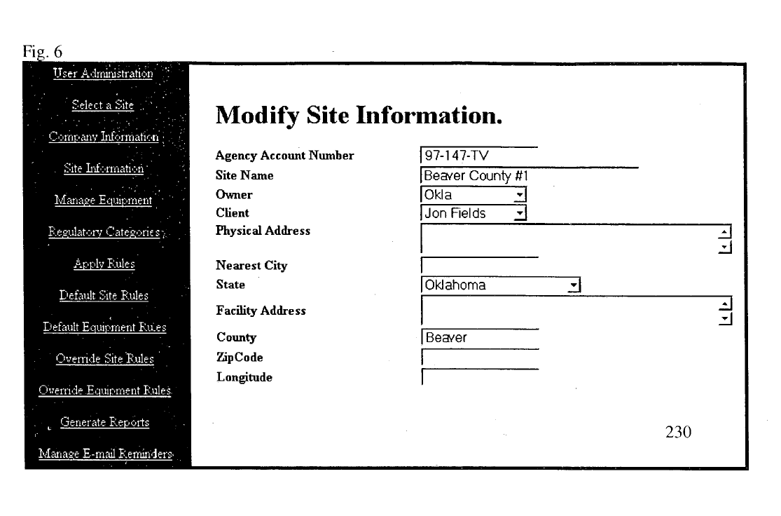

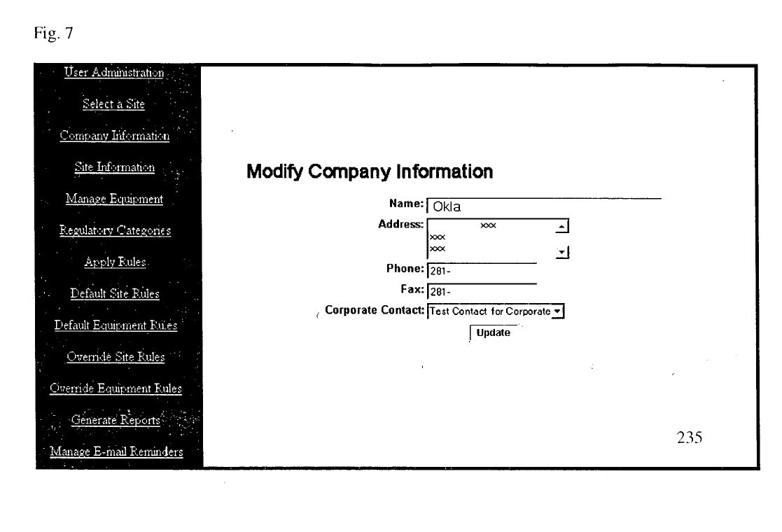

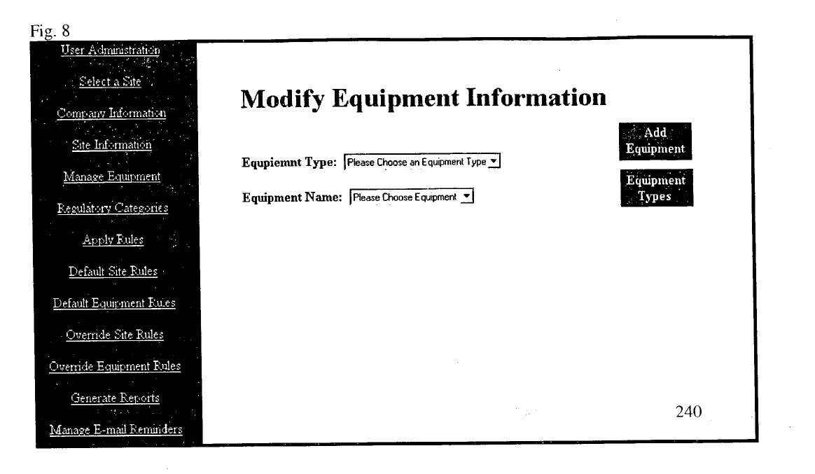

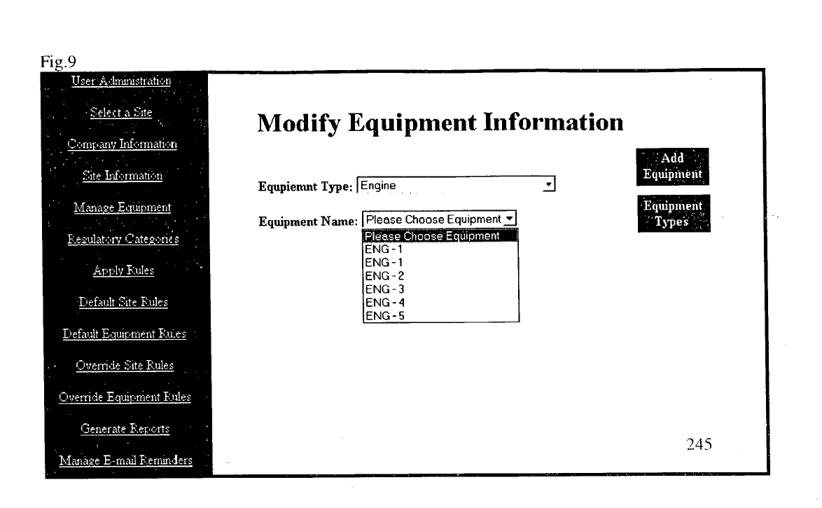

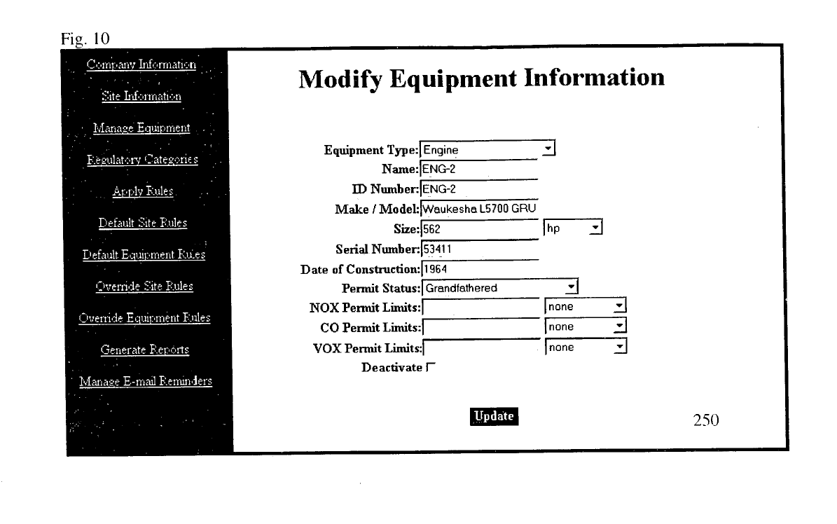

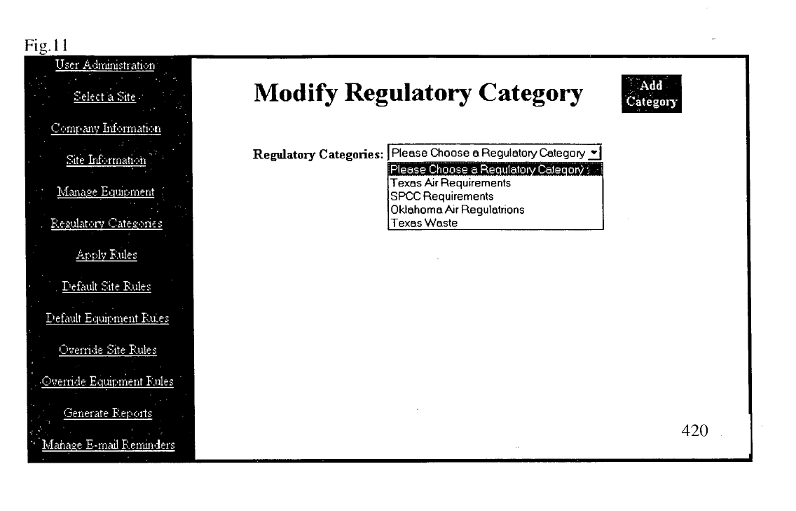

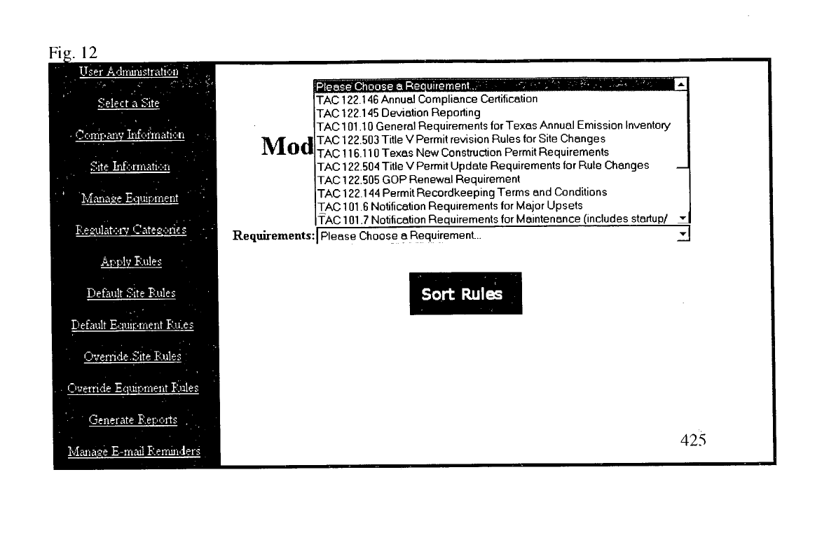

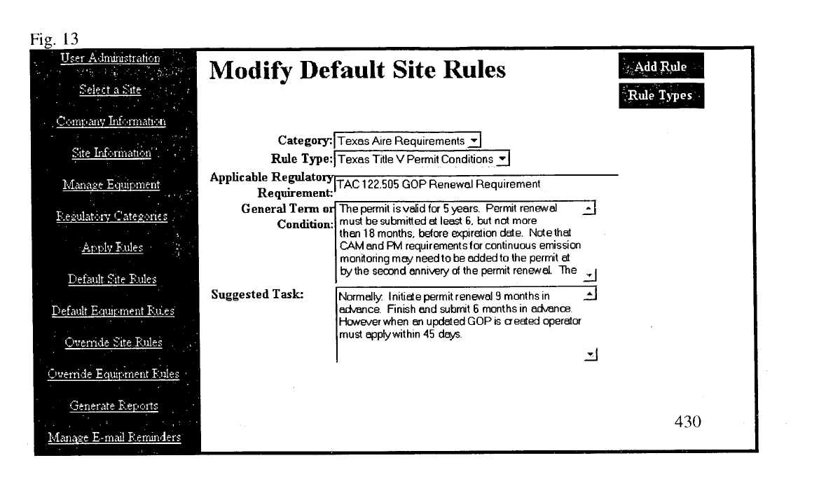

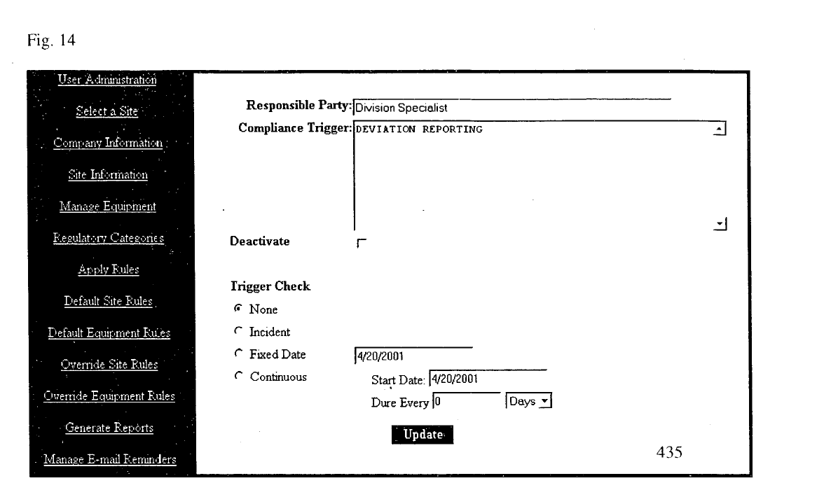

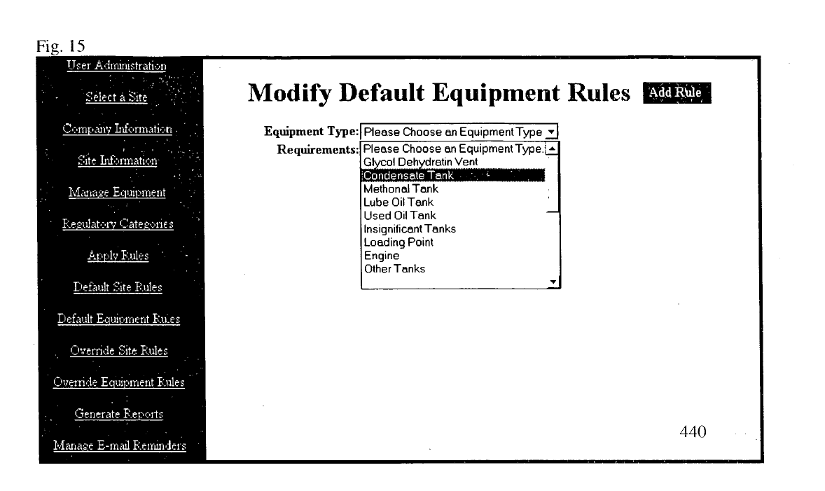

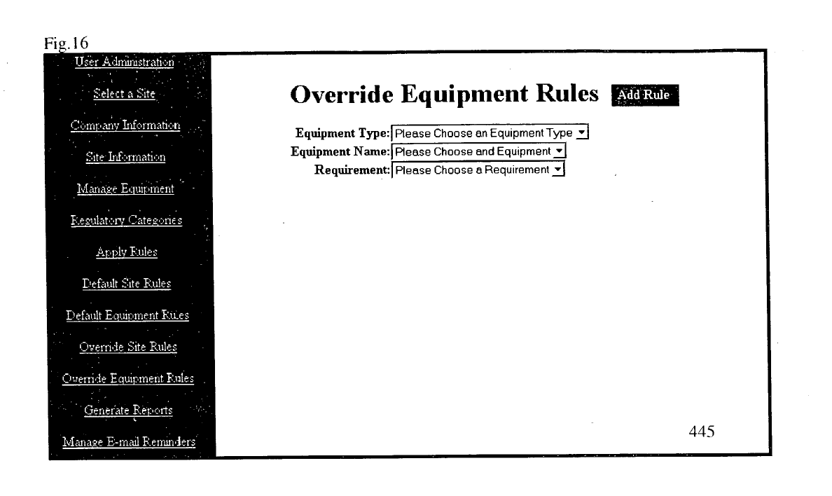

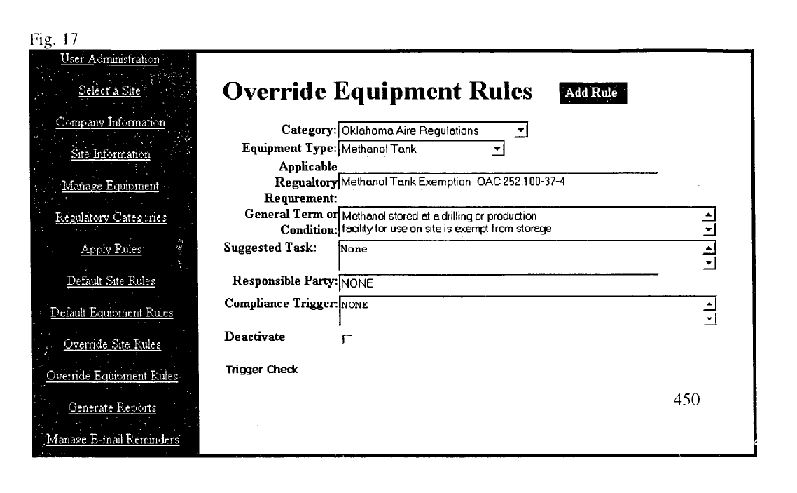

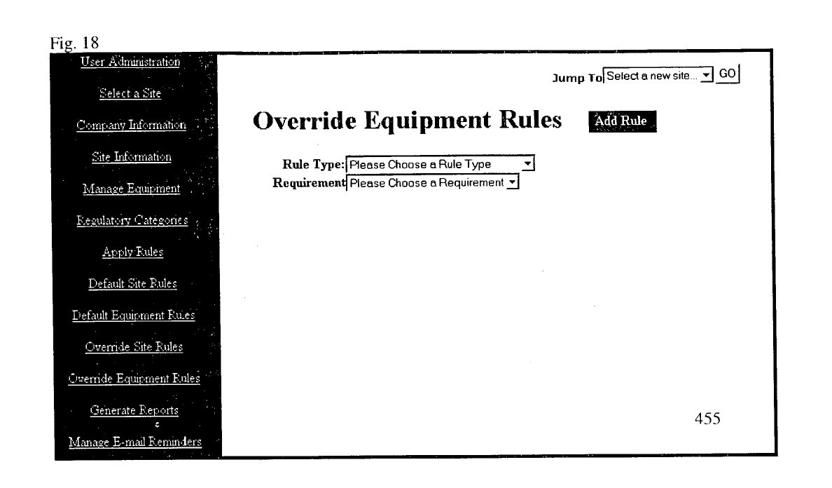

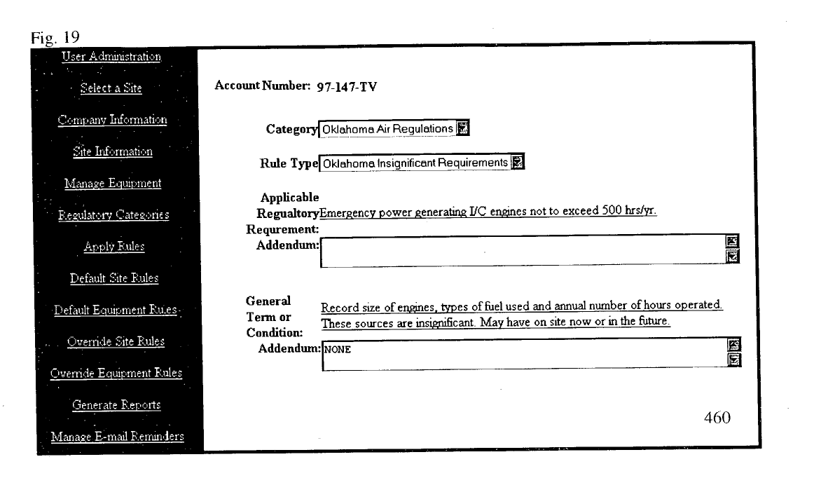

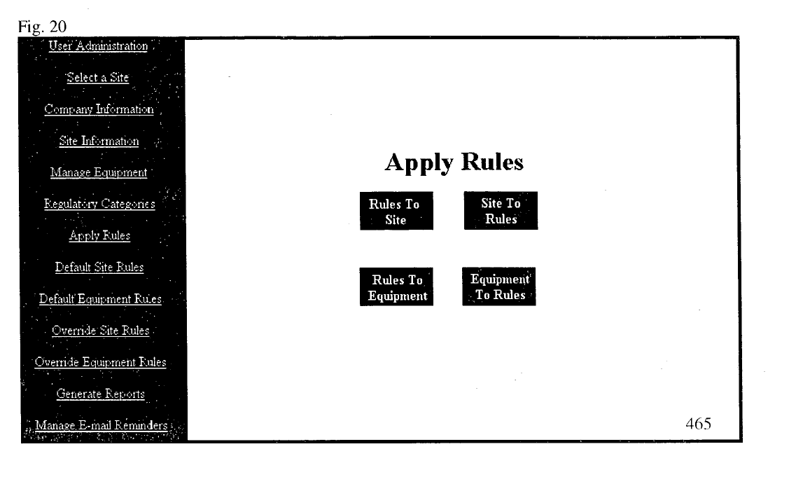

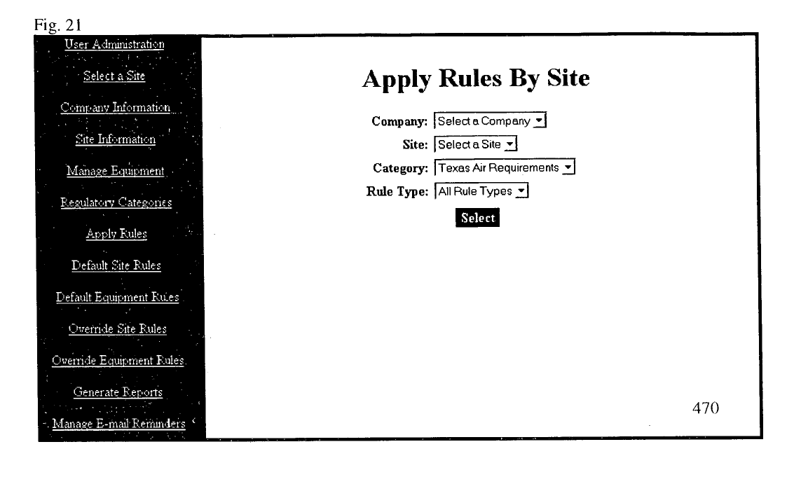

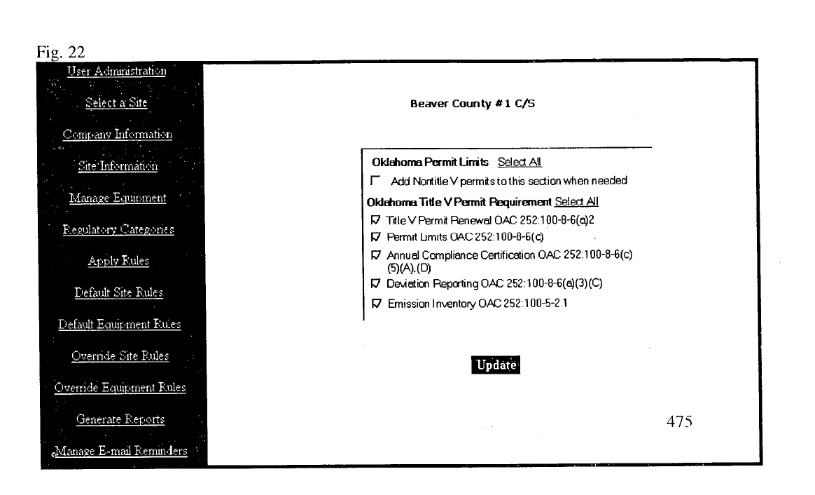

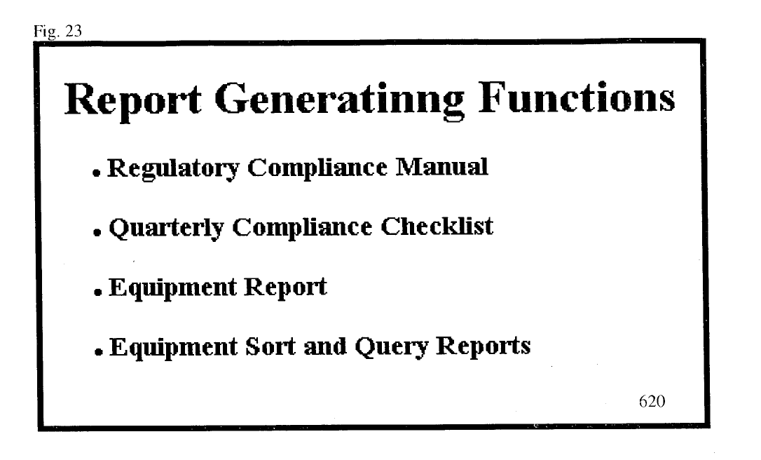

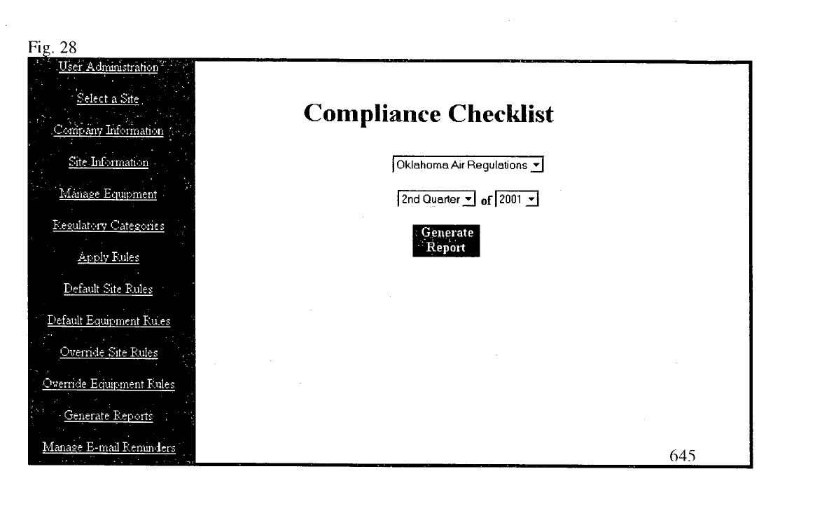

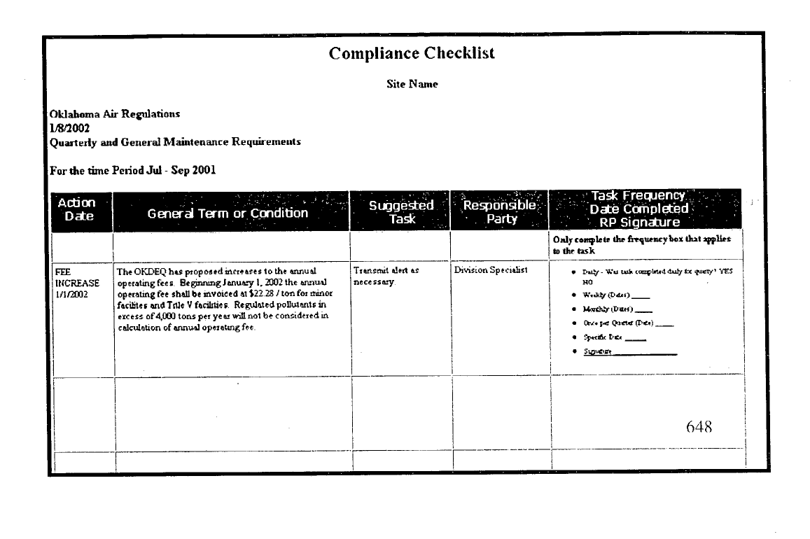

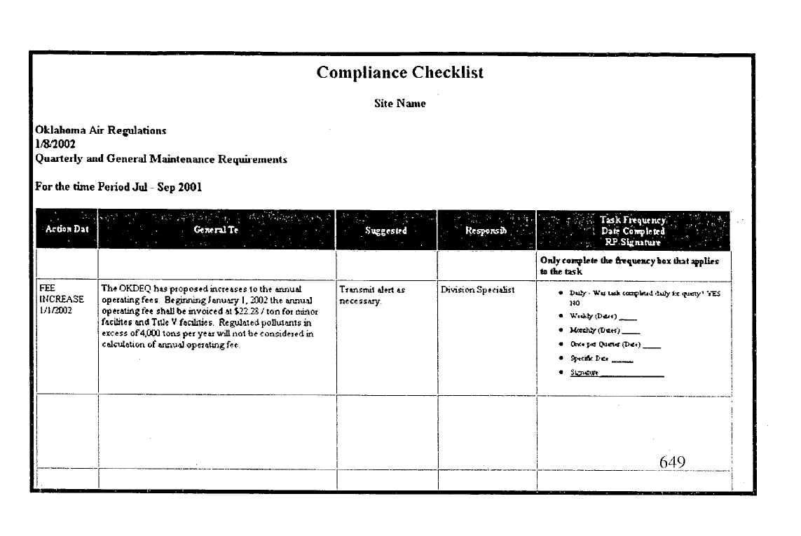

The method and system of this invention is applicable to a wide array of companies, industries, businesses and organizations that must comply with rules and regulations. For the illustrative purposes of explanation during this description, FIGS. 3 through 31 and the appendices refer to a particular plant but do not limit this method and system to any particular application. Referring to FIG. 4, the authorized user can select a company and a site, 220 from previously input company data, to determine its compliance requirements. The authorized user identifies facility subject items subject to regulatory compliance applicable for the specific user's company or organization, FIG. 1, 120 to determine its compliance status and requirements. Referring to FIGS. 5-10, the system confirms the selection, 225 and allows the authorized user to modify site information 230 or company information 235 if changes have been made since the initial input of data. The equipment at that site can be identified 240 and information entered, updated and modified if necessary 245, 250. In one embodiment, the information can comprise name of the equipment, ID numbers, serial numbers, site location, date of construction, permit status, permit limits and any other pertinent information required to identify the equipment and insure compliance.

Once the subject item has been selected, the regulatory compliance system and method of this invention selects the applicable rules for the selected subject item from the compliance data that is within the database 130, 131 and generates a report listing the compliance rules, tasks, and due dates. The information resulting from the step of applying the rules 140, 142 is based upon regulatory compliance data 130, 131 and subject items 120, 122, 124, 126 previously entered into the one or more databases. The step of applying the rules means applying the compliance data to one or more specific subject items. This step of applying the rules uses the query, sort and find functions 150 and can be automatically processed by a database engine of a computer processor or manually performed by a user, for example, the administrator of the system. Other interactive functions such as a reminder function and a reporting function 170 to generate reports and reminders for responsible persons are also embodied within the preferred system.

In one aspect of this method, the step of applying the rules using the query, sort and find functions 150 is performed by a database engine which generates compliance data for the identified subject items. The compliance data can comprise regulatory compliance data for subject items input by user, applicable compliance requirements, tasks required, compliance triggers necessary to fulfill compliance requirements for substantially each identified subject item. The triggers can include the due date for performing the required task and the responsible person for performing the required task. Preset triggers can also include specific events such as a storm surge or an accidental fire that will trigger compliance requirements.

Referring to FIGS. 11-19, the authorized user can modify or override the default settings for the automated selection of rules by modifying regulatory categories to select specific categories 420. The requirements 425, site rules 430, triggers, 435, and equipment rules 440-460 can also be modified so that the default settings are overruled.

Referring to FIG. 20, 465, the user has options of how the compliance rules are applied to the various subject items by means of a variety of functions programmed into the system. The user can apply the rules to the site, FIG. 21, 470, meaning that all rules to a specific site can be displayed. The rules can also be applied to a specific piece of equipment (rules to equipment) to bring up every rule in the database that applies to that piece of equipment. The functions can also list a single rule with all the equipment affected by that rule, as well as a single rule and all sites affected by that rule. FIGS. 21 and 22 illustrate the function of all rules applicable to a specific site.

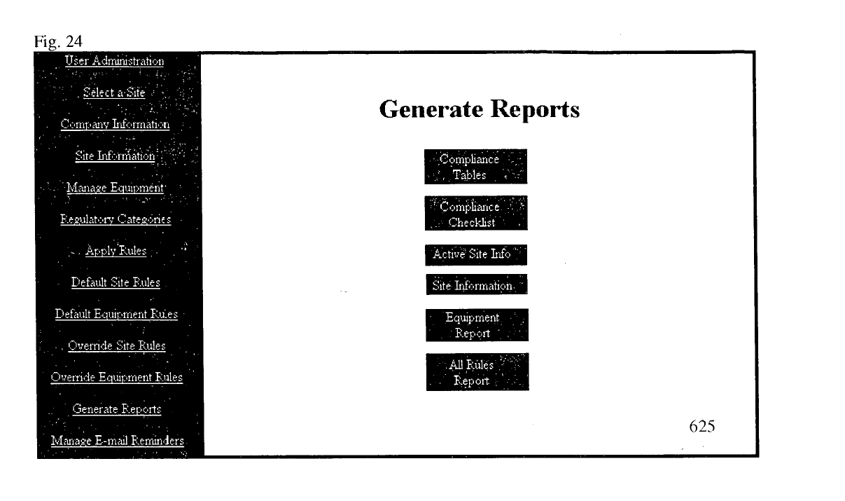

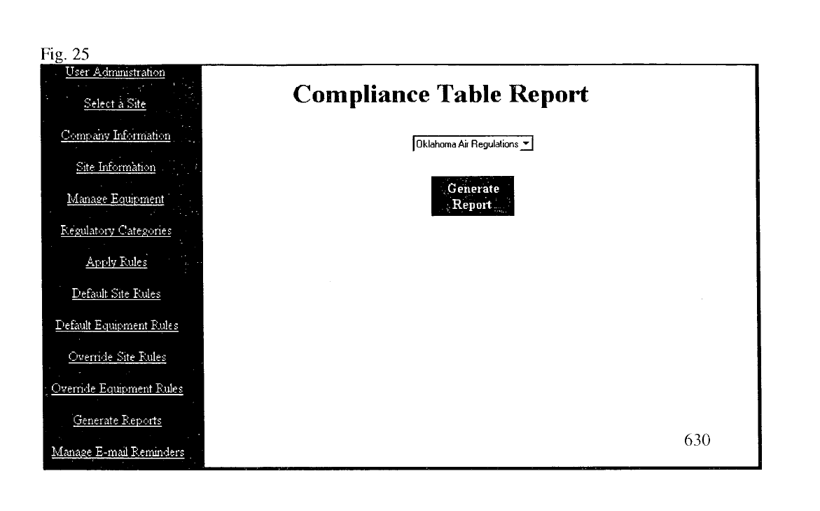

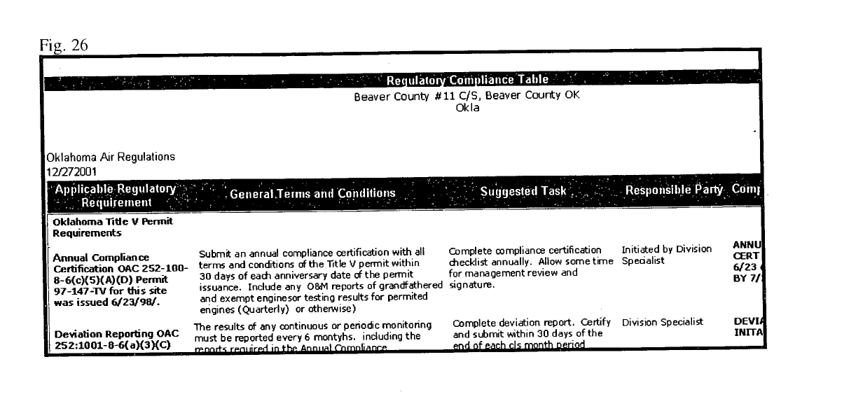

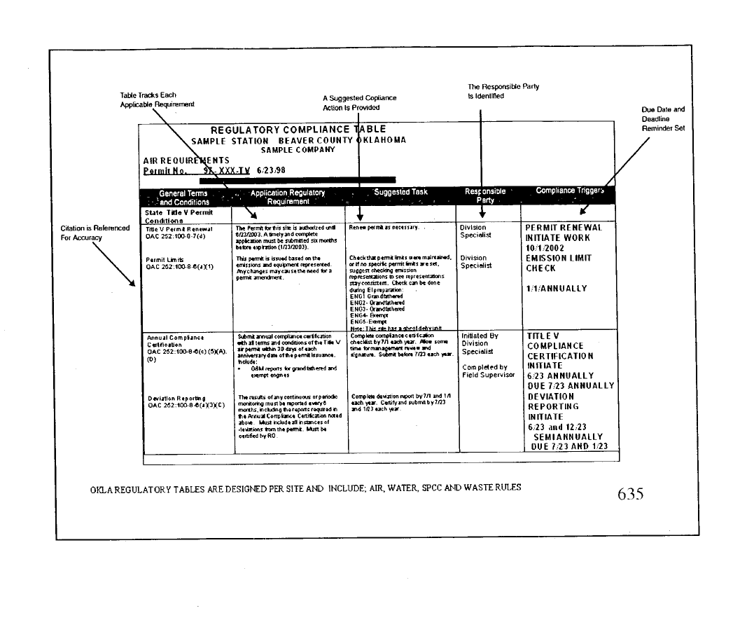

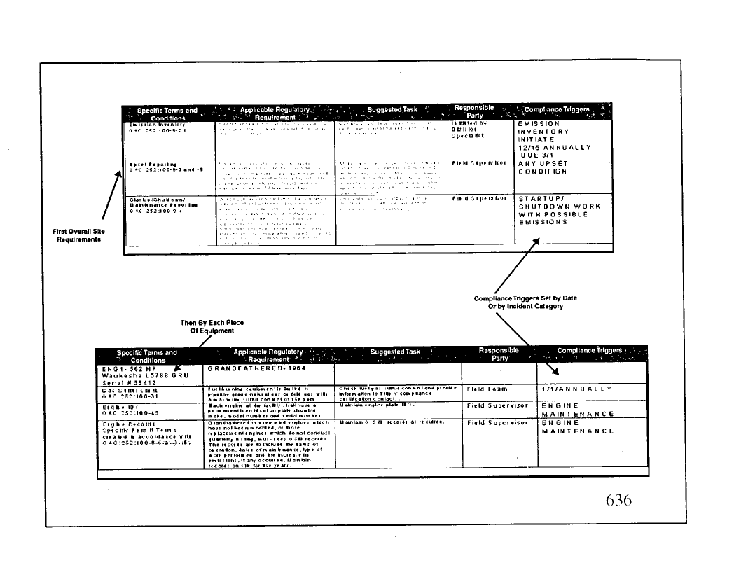

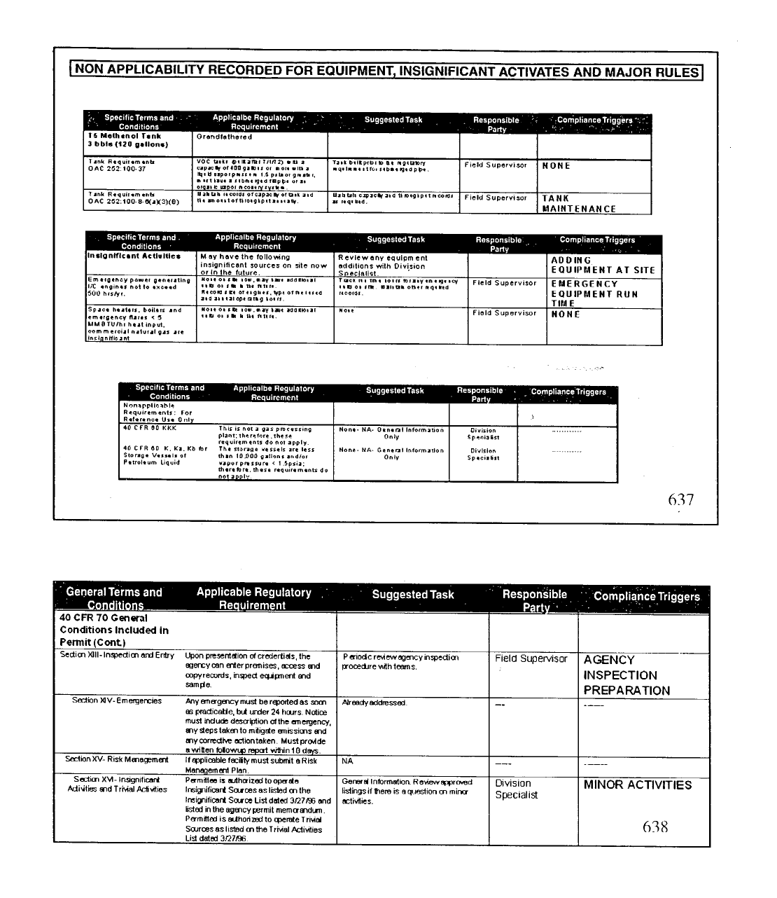

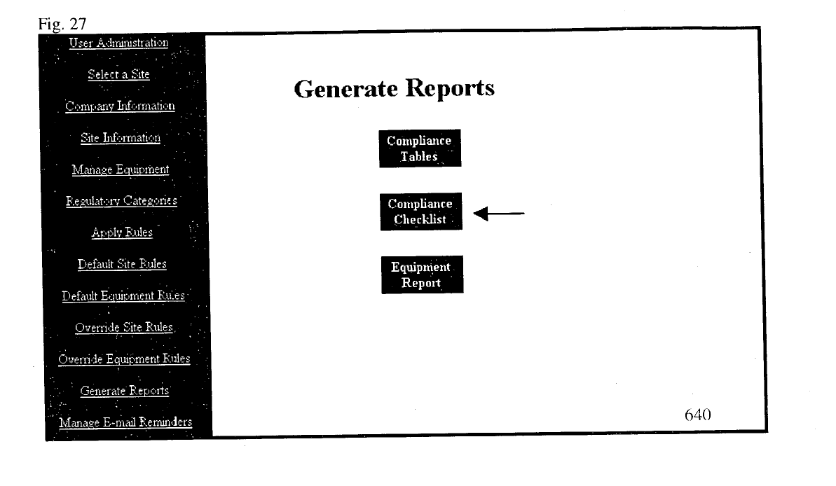

The compliance requirement data is provided to authorized users by report generators 160 that generate one or more reports and reminders 170. The authorized user can generate a report by selecting a specific reporting method 465. FIG. 23 is a web page that lists the report generating functions available; for example, the report functions can include regulatory compliance, quarterly compliance checklists, an equipment report and equipment sort and query reports 620. The various types of data reports 180 that are available are provided to the authorized user as shown in FIG. 24 and can comprise one or more checklists 175, one or more compliance tables, one or more equipment query reports, one or more site information reports, one or more activity site information reports, one or more equipment lists, one or more inventory reports or combinations thereof. In the method of this invention, the user can initiate the reports 171-176 that result from the query, sort and find functions 150 of this system. User initiated compliance reports 173, compliance checklists 175, equipment reports 174, activity reports 176 and site and company information reports 172 can be generated. The authorized user can also generate a report of all the compliance rules applicable to its facility or site, FIG. 25. FIGS. 26 to 31 illustrate the web pages for the various reports available. A compliance table report as shown in FIG. 26, reference numbers 636-639, is printed in its entirety as Appendix A. As shown in FIG. 26, 635, this is a site compliance report for Air Regulations and includes applicable regulatory requirements, an explanation of the general terms and conditions for compliance, the task that must be accomplished to comply, the person responsible to complete the task and the activity triggers that initiate compliance to that regulation.

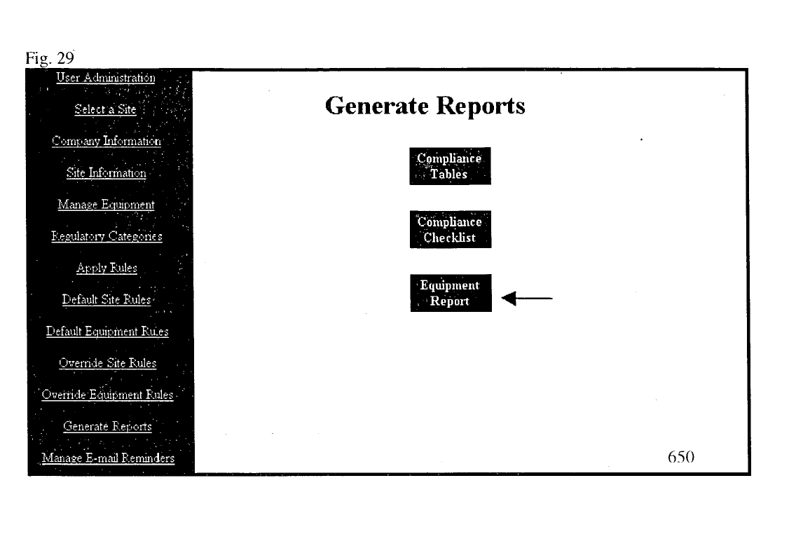

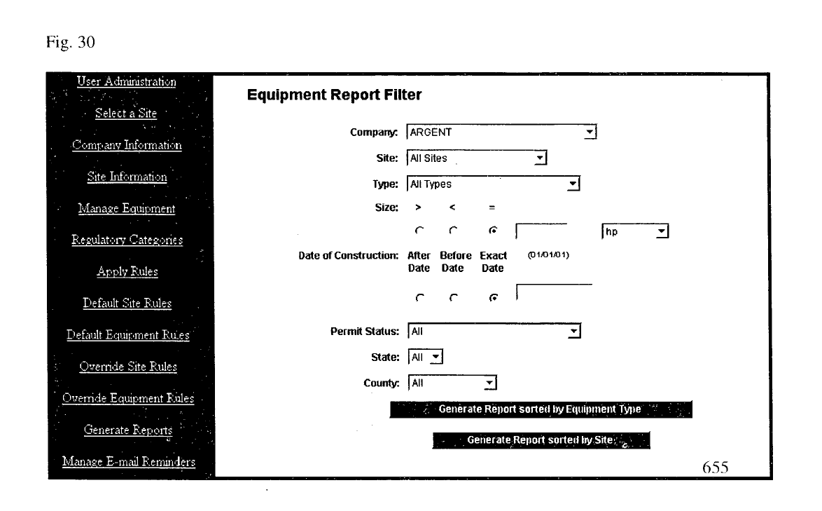

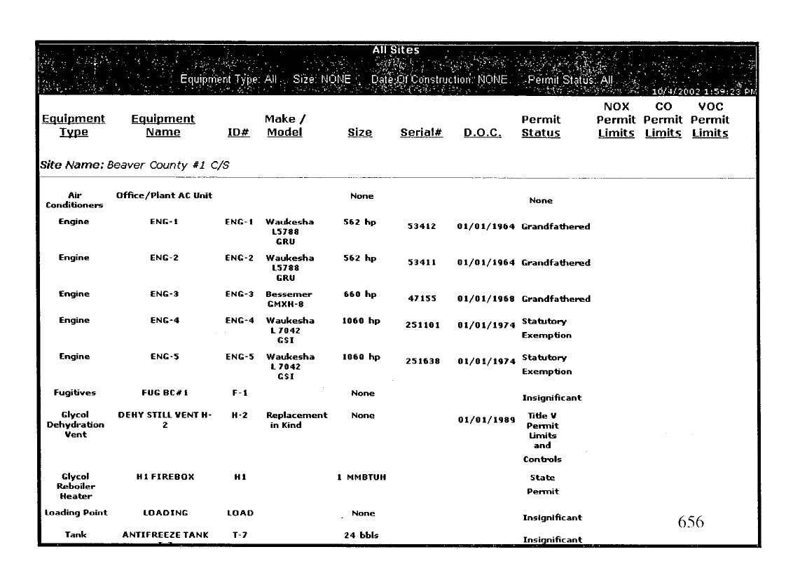

As illustrated in FIG. 27, reference numbers, 640, 645, 648, 649, a checklist can be generated so that compliance activities and the dates of compliance can be recorded. The responsible person can sign off when compliance has occurred, 649. FIG. 29 illustrates an equipment report that can list substantially all the equipment for all sites of a client user and the compliance rules and requirements for each piece of equipment so that the client user can have a complete inventory report of all its equipment. 650, 656. As seen in FIG. 30, 655, a filter can be used to limit the report function to specific equipment 655. Reference 656 illustrates a report of equipment at all sites and the applicable compliance requirements. In one preferred embodiment, the reports generated from the subject items and compliance requirement databases are: compliance reports, site information reports, equipment lists and inventory lists. A company can maintain its inventory on the system as embodied by this invention, if the company so desires.

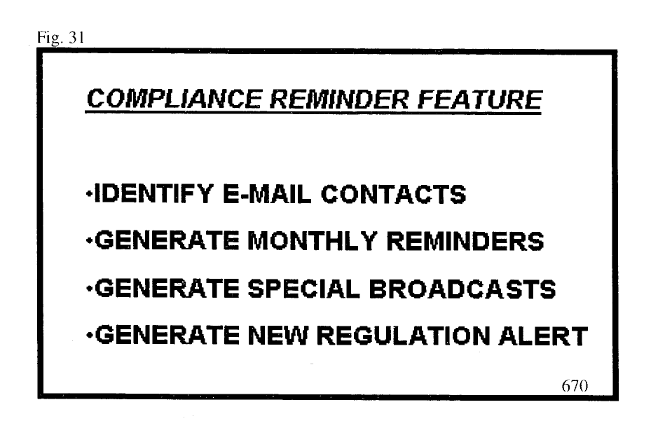

It is important that the compliance requirement data is provided to a responsible person for carrying out compliance tasks in a timely manner. Referring to FIG. 2, 171 and FIG. 31, 670, the method and system of this invention provides various types of reminders to responsible persons by means of its reminder and broadcast functions 150. The system itself can initiate reminders based on compliance triggers 171, preferably preset compliance triggers according to due dates or other triggering functions as required by the compliance rules and regulations. Alternatively, a system maintenance administrator can determine and generate reminders. FIG. 31 is a web page of the types of reminders available to responsible persons. The responsible person can be notified by email, fax, phone, postal mail or other method to timely inform the person of the compliance requirement. A broadcast function 190 can be part of this system to generate special broadcasts of computer-generated emails to multiple users and/or clients affected by triggering activities, for example, storm surges or disaster conditions.

A regulatory compliance system according to one embodiment of this invention comprises a web site hosted by a server, the web site accessible on a LAN or a WAN network connectivity to multiple computers, the World Wide Web for example. A data structure 200 can be located on the web site comprising one or more relational databases 200. Preferably, the one or more relational databases 200 comprise regulatory compliance data, i.e. rules and regulations of various compliance agencies, client information data, and subject items that require regulatory compliance, the subject items comprising facility sites, equipment, materials and activities subject to regulatory compliance. The client data can identify specific subject items and authorized user data. One or more secured, interactive web pages are available to authorized users for enabling users to input access data for accessing compliance data relating to specific subject items.

A database engine comprising one or more query, sort and find software is accessible to authorized users. A computer security system to limit access to authorized persons is part of the regulatory compliance system. Such security systems are well known. The compliance data can comprise compliance data for specific subject item comprising applicable compliance requirements, tasks required, due date for performing required task and responsible person for performing required task. One or more report generators are used to generate one or more reports for specific subject items input by client user, the one or more reports comprising compliance data for one or more specific subject items input by client user. The reports can comprise one or more checklists, one or more compliance tables, one or more equipment query reports, one or more site information reports, one or more equipment lists and one or more inventory reports. The checklists can comprise substantially each subject item within the facility, one or more compliance tasks required and a verification signature of the responsible person. Preferably one or more pre-set time triggers are available for each required compliance task to notify the responsible person of compliance task and its due date.

In one preferred use of the method and system of compliance, authorized users have access to very specific compliance data and subject items subject to compliance, such as weather data required to comply with storm water sampling regulations, wherein the method notifies users of a specified chance of rain fall and notification of actual rainfall. Storm surges are problematic to waste water facilities and sewer drainage systems. Government agencies and responsible companies use the compliance method and data provided by this embodiment to comply with rules and regulations governing such conditions. This weather data is sent to users of the system.

One preferred compliance method continually provides notifications of compliance requirements and task notifications to responsible persons along a management hierarchy chain of command until each requirement and task is completed or the due date has passed. The compliance method uses a software program for automatically providing email reminders of compliance requirements and tasks to a responsible person along a management hierarchy chain of command until the task is ticked off on the checklist. In addition, the compliance method is capable of sending a notice of potential non-compliance to a designated authority for any one or more tasks not completed by its due date.

One preferred compliance method and system further comprises the step of sending a notice of potential non-compliance to a designated authority for any one or more incomplete tasks. A checklist of compliance requirement tasks is included that is to be ticked off upon completion of each task required for compliance according to the compliance data. The checklist comprises substantially each subject item within an authorized facility that is subject to compliance data, one or more required compliance tasks for each item, and identification data for the responsible person to perform the one or more required compliance tasks. A verification signature is required on the checklist. Notices will continue to be sent until the signature is entered.

A preferred method for facilitating compliance comprises providing a system for facilitating compliance that is accessible on a secured, interactive web site. The system of the method comprises compliance data and subject items subject to compliance. The method for facilitating compliance further comprises identification of specific subject items for a client and compliance requirements for specific subject items, defining priority levels of triggers based on the specific subject items and compliance requirements, and defining groups of client personnel authorized to receive trigger notification. The groups are prioritized according to management hierarchy and priority level of trigger. The method for facilitating compliance additionally comprises sending reminder notices to client personnel based on management hierarchy level and trigger priority level. The reminder notices are sent by email, fax or telephonic communication.

Another preferred method of this invention is especially useful for facilitating compliance with environmental rules and regulations. This system for facilitating compliance is accessible on a secured, interactive web site. The web site is accessible to multiple computers via network connectivity. The system comprises compliance data including environmental compliance rules and regulations, required compliance tasks and subject items subject to environmental compliance, and determination of the environmental compliance rules and regulations and tasks applicable to specific subject items. Access to the system is limited to authorized users.

In an alternative preferred embodiment, the compliance system comprises a web site hosted by a server accessible by multiple computers. The compliance system further comprises one or more secured, interactive web pages accessible to authorized users for enabling users to determine applicable compliance requirements and required tasks, a means for notifying a responsible person of the compliance requirements and tasks, a checklist for ticking off completed tasks required for compliance, and hyperlinks to a regulatory database comprising full text of compliance rules and required tasks.

In one embodiment, the hyperlinks to a government regulatory database comprises a full text of compliance rules and required tasks, a software program for automatically comparing the summary of compliance rules and tasks to the government regulatory database for updating the rules and tasks, and one or more secured, interactive web pages located on the web site. The web pages are accessible to authorized users for enabling users to determine updated compliance data, rules and required tasks. Preferably, the software program comprises a means for alerting the authorized user to the update of the rules and tasks. The means for alerting a responsible person to the update of the rules and tasks can comprise an automated email system, a fax alert or telephone call.

Preferably, the compliance system maintains a data structure on the server, the data structure comprising compliance data, a summary of compliance rules and tasks required for compliance, one or more secured, interactive web pages located on the web site accessible to authorized users, and a software program for responding to an unscheduled event requiring one or more compliance tasks. The software program comprises compliance data for tracking and reporting the unscheduled event. Examples of unscheduled events are failure of equipment, changes to equipment operations, and disasters.

System Functions

One preferred embodiment of the system design includes the following functional components:

Administrative Data Entry

Company Information

Site Information

Client E-Mail Contacts

Permit Information

Regulatory Compliance Online Tables

Complete Table Per Facility

Applicable Rule Summary for Site and Individual Pieces of Equipment

Recommended Compliance Task

Identify Responsible person for Compliance Task

Identify Compliance Triggers

Useful for Compliance Reviews and Certifications

User Generated Checklist

Quarterly Checklist Generated for Any Quarter

Checklist Per Individual Facility and Equipment

Provides Option for Completion Verification Signature

Useful for Compliance Reviews and Certifications

Equipment Report and Queries

Identify All Regulated Equipment

Include Complete Description

Allows Management Queries for Impact Analysis

Reporting

View All Information Online

Also Can Generate Hard Copies of All Reports and Queries

Security

Administrator Security

User Security

Reporter Security

EIS Manager Security

Management Security

E-mail Notifications As Requested By User

Responsible Party Contacts

Individual Site Contacts

Management Contacts

Applicable Uses of Regulatory Compliance System and Method

The regulatory compliance system and method of this invention can be adapted for use with the following:

Environmental On-Line Regulatory Service

DOT On-Line Regulatory Service

OSHA On-Line Requirement Service

Safety and Health On-Line Requirement Service

HAZMAT On-Line Training Modules

Environmental Regulatory On-Line Training Modules

Emergency Incident Requirements Tables

MMS On-Line Regulatory Reminder Service

Federal, State or Local Tax Regulatory Reminding Service

Environmental Management On-Line Training System

Mechanical Operation and Maintenance On-Line Tickler System

Environmental On-Line Interactive Training Modules

Education On-Line Interactive Training Modules

On-Line Equipment Inventory Tracking and Reporting

On-Line Environmental Inspection Preparation Guidance

On-Line OSHA Inspection Preparation Guidance

On-Line Fleet Vehicle Requirements

On-Line Management of Fleet Services-Environmental, Mechanical and Accounting Requirements

On-Line Environmental Sampling and Testing Protocol Tables

On-Line Step by Step Up to Date Requirements and Options for CEMS-Continuous Emission Monitoring Systems

Biomedical Waste Management Compliance Service For Hospitals

On-Line Waste Handling Compliance Manual For Various Industries

BroadBand Industry Requirements On-Line

Environmental Compliance For Education Facilities—On-Line For schools, universities and research facilities

Environmental Compliance Service For Tall Buildings—Information and Reminders

Environmental Compliance Service For Small Businesses In Houston—What you need to know and what you need to do

On-Line Environmental Compliance Service For Paints Shops

On-Line Environmental and Safety Compliance Service For Auto Shops

On-Line Environmental and Safety Compliance Service for Construction Businesses

On-Line Environmental Compliance for Airports

On-Line Environmental and Waste Management Requirements for Food Service Businesses

On-Line Regulatory Compliance Reminders for Printers

On-Line Regulatory Compliance Reminders for Dry Cleaners

On-Line Human Resources Compliance Reminders

Implementation of Regulatory Compliance System

In one preferred practice of this invention, the Applicant works with key client companies and organizations to identify and enter site and facility information. Field Compliance Surveys may be utilized. The Applicant can interview field contacts as necessary to collect additional site data. The Applicant questions office contacts to collect regulatory history, including copies of site and equipment permits or registrations. Applicant gathers all applicable regulations for state and federal compliance requirements for each site. Local regulations and company policies and procedures are included when applicable. Applicant assigns applicabilities and explains non-applicabilities where useful. The Applicant then requests identification of Responsible persons for various compliance tasks. Applicant can request access to technical and regulatory company or organizational contacts for review and approval of compliance deadline ‘lead times’, regulatory interpretations, equipment data and the finished product.

In one preferred method and system of this invention, the Applicant consistently maintains and periodically updates the website with regulatory information, agency information and any changes to compliance deadlines. Other changes to site or equipment data are made as necessary.

The foregoing description is illustrative and explanatory of preferred embodiments of the invention, and variations in the method, systems and other details will become apparent to those skilled in the art. It is intended that all such variations and modifications which fall within the scope or spirit of the appended claims be embraced thereby.

1. A method for facilitating compliance comprising:
(a) providing a system for facilitating compliance that is accessible on a secured, interactive web site, the web site accessible to multiple computers via network connectivity, the system comprising compliance data including compliance rules and regulations, subject items subject to compliance, and compliance tasks required for the subject items, accessibility to the system limited to authorized users;
(b) identifying specific subject items;
(c) determining the required compliance rules and regulations and required tasks applicable to the identified subject items.

2. The method of claim 1 wherein the web site is accessible on a LAN system.

3. The method of claim 1 wherein the web site is accessible on a WAN system.

4. The method of claim 1 wherein compliance data comprises compliance requirements data emanating from one or more laws, statutory codes, government rules and regulations, permit requirements, government standards, industry standards, rules and procedures, company procedures and guidelines, procedures and guidelines of one or more regulatory authorities or combinations thereof.

5. The method of claim 1 wherein the subject items comprise facility sites, equipment, materials and activities subject to compliance.

6. A method for facilitating compliance comprising:
(a) providing a system for facilitating compliance that is accessible on a secured, interactive web site, the web site accessible to multiple computers via network connectivity;
(b) providing one or more databases within the system, the databases comprising compliance data and subject items subject to the compliance data, accessibility to the one or more databases limited to authorized users;
(c) identifying subject items subject to compliance applicable for a specific authorized user;
(d) applying compliance data to identified subject items to determine compliance requirements and tasks applicable to that subject item;
(e) providing resulting compliance requirements and tasks to person responsible for compliance.

7. The method of claim 6 wherein the web site is accessible on a WAN system.

8. The method of claim 6 wherein compliance data comprises compliance requirements data emanating from one or more laws, statutory codes, government rules and regulations, permit requirements, government standards, industry standards, rules and procedures, company procedures and guidelines, procedures and guidelines of one or more regulatory authorities or combinations thereof.

9. The method of claim 8 wherein the one or more regulatory authorities comprise government legislatures, government agencies, industry associations, and company organizations.

10. The method of claim 6 wherein the compliance data further comprises recommended tasks for compliance and compliance triggers for performing the recommended tasks.

11. The method of claim 6 wherein the step of applying the compliance data further comprises determining the compliance requirements for identified subject items triggered by compliance triggers.

12. The method of claim 6 wherein the subject items comprise facility sites, equipment, materials and activities subject to compliance.

13. The method of claim 6 wherein the compliance requirement data is provided to authorized users by report generators that generate one or more reports.

14. The method of claim 6 wherein the reports comprise one or more checklists, one or more compliance tables, one or more equipment query reports, one or more site information reports, one or more equipment lists, one or more inventory reports or combinations thereof.

15. The method of claim 6 wherein the compliance requirement data is transmitted to a responsible person for carrying out compliance tasks.

16. The method of claim 15 wherein the compliance requirement data is transmitted to a responsible person by reminders, the reminders comprising email, fax or telephone communications.

17. The method of claim 6 wherein the step of applying compliance data to identified subject items to determine compliance tasks is performed by a computer processor.

18. The method of claim 17 wherein the system for facilitating compliance further comprises one or more interactive functions, the interactive functions comprising a query, sort and find function for determining compliance data applicable to identified subject items, a reminder function and a reporting function to generate reports to notify one or more responsible persons of compliance requirements.

19. A method for facilitating compliance comprising:
(a) providing a system for facilitating compliance that is accessible on a secured, interactive web site, the web site accessible to multiple computers via network connectivity;
(b) inputting compliance data and subject items into one or more relational databases; accessibility to the relational databases limited to authorized client users;
(c) identifying one or more subject items input in step (b) that are applicable to a specific user;
(d) using a query, sort and find function, applying compliance data to determine compliance requirements, compliance triggers, and required tasks necessary to fulfill compliance requirements for substantially each identified subject item;
(e) providing the compliance requirements, triggers and required tasks to a responsible person for carrying out compliance tasks;
(f) using a report function to generate one or more compliance reports at any time during this method;
(g) notifying the responsible person regarding compliance requirement data and compliance dates by reminders.

20. The method of claim 19 wherein the compliance requirement data is provided to a responsible person according to preset tickler system.

21. The method of claim 19 wherein the reports comprise one or more checklists, one or more compliance tables, one or more equipment query reports, one or more site information reports, one or more equipment lists, one or more inventory reports and combinations thereof.

22. A method for facilitating compliance comprising:
(a) providing a system for facilitating compliance that is accessible on a secured, interactive web site, the web site accessible to multiple computers via network connectivity;
(b) providing one or more relational databases comprising compliance data and subject items, the compliance data comprising compliance requirements, compliance tasks to satisfy compliance requirements and due dates for tasks, the subject items comprising facility sites, equipment, materials and activities, accessibility to the relational databases limited to authorized users;
(c) inputting data to identify a company client including one or more company facilities;
(d) identifying substantially each subject item located at the one or more company facilities;
(e) determining substantially each compliance requirement, substantially each compliance task and the compliance date for the task required for the subject items identified in step (d);
(f) identifying the responsible person to carry out the compliance task;
(g) notifying each responsible person of substantially each required compliance task and compliance date.

23. The method of claim 22 wherein the web site is accessible on a LAN system.

24. The method of claim 22 wherein the web site is accessible on a WAN system.

25. The method of claim 22 wherein the compliance requirements, compliance task required and the compliance date for identified subject items are determined by a computer processor.

26. The method of claim 22 wherein the compliance requirements, compliance task required and the compliance date are determined by a user.

27. The method of claim 22 wherein the responsible person is notified by reminders.

28. The method of claim 22 wherein the responsible person is notified of one or more upcoming compliance dates according to a preset tickler system.

29. A method for facilitating compliance comprising:
(a) providing a system for facilitating compliance that is accessible on a secured, interactive web site, the web site accessible to multiple computers via network connectivity;
(b) providing one or more databases on the system, the databases comprising compliance data, client data and subject items, the subject items comprising facility sites, equipment, materials and activities, accessibility to the databases limited to authorized users;
(c) determining client-specific subject items;
(d) using a computer processor, applying query, sort and find functions to compliance data to identify compliance requirements for substantially each client-specific subject item;
(e) determining the compliance tasks and due dates required for substantially each compliance requirement identified in step (d);
(f) generating one or more reports for client-specific subject items based on the compliance requirements, compliance tasks and due dates;
(g) notifying a responsible person of the required compliance task and compliance date.

30. The method of claim 29 wherein the reports comprise one or more checklists, one or more compliance tables, one or more equipment query reports, one or more site information reports, one or more equipment lists, one or more inventory reports and combinations thereof.

31. The method of claim 29 further comprising one or more reminder functions.

32. A method for facilitating compliance comprising:
(a) providing a system for facilitating compliance that is accessible on a secured, interactive web site, the web site accessible to multiple computers via network connectivity;
(b) creating one or more databases comprising compliance data requirements, client information data and subject items, the subject items comprising facility sites, equipment, materials and activities, accessibility to the databases limited to authorized users;
(c) inputting client-specific subject items;
(d) using query, sort and find function, applying compliance data requirements to identify compliance requirements for substantially each client-specific subject item;
(e) determining the compliance tasks and due dates required for substantially each compliance requirement identified in step (d);
(f) accessing the client-specific subject items, compliance requirements and compliance task determined in step (e), accessibility to data securely limited to authorized users;
(g) generating one or more reports for client-specific subject items based on the compliance requirements, compliance tasks and due dates;
(h) notifying a responsible person of the required compliance task and compliance date according to a preset tickler system.

33. The method of claim 32 wherein the subject items comprise facility sites, equipment, materials and activities subject to compliance.

34. A compliance system comprising:
a system for facilitating compliance that is accessible on a secured, interactive web site, the web site accessible to multiple computers via network connectivity;
a data structure located on the web site, the data structure comprising one or more databases comprising compliance data and subject items;
one or more secured, interface means for enabling authorized users to identify specific subject items located on the one or more databases;
a database engine, comprising query, sort and find software, for accessing the one or more databases to generate compliance requirements for the one or more specific subject items identified by the user.

35. The compliance system of claim 34 further comprising one or more preset tickler systems for providing compliance requirement data for the subject items to authorized users according to their due date.

36. The compliance system of claim 34 wherein the subject items comprise facility sites, equipment, materials and activities subject to compliance.

37. The compliance system of claim 34 further comprising a report generator to generate reports, the reports comprising one or more checklists, one or more compliance tables, one or more equipment query reports, one or more site information reports, one or more equipment lists, one or more inventory reports or combinations thereof.

38. A compliance system comprising:
a secured, interactive web site, the web site accessible to multiple computers via network connectivity;
a data structure located on the web site server comprising one or more databases comprising compliance data, client information data and subject items;
one or more secured, interface means for enabling authorized users to identify specific subject items;
a database engine comprising one or more query, sort and find functions, for accessing the database to generate compliance data relating to specific subject items; and
a report generator to generate reports based on data generated by database engine.

39. The compliance system of claim 38 further comprising one or more preset tickler systems for providing compliance requirement data for the subject items to authorized users according to the due date.

40. The compliance system of claim 38 wherein the subject items comprise facility sites, equipment, materials and activities subject to compliance.

41. A compliance system comprising:
a secured, interactive web site, the web site accessible to multiple computers via network connectivity;
a data structure located on the web site comprising one or more relational databases, the one or more relational databases comprising compliance data, client information data, and subject items that require compliance, the subject items comprising facility sites, equipment, materials and activities subject to compliance, the client data identifying specific subject items, the client data further comprising authorized user data;
one or more secured, interactive web pages accessible to authorized users for enabling users to access compliance data relating to specific subject items;
a database engine comprising one or more query, sort and find software to generate compliance data for specific subject items, the compliance data comprising applicable compliance requirements, tasks required, due date for performing required tasks, triggers if any, and the identity of the one or more responsible persons for performing required tasks.

42. A compliance system comprising:
a web site hosted by a server, the web site comprising a computer server accessible by multiple computers;
a data structure located on the web site comprising one or more relational databases, the one or more relational databases comprising compliance data, subject items that require compliance, and client data, the subject items comprising facility sites, equipment, materials and activities subject to compliance, the client data identifying specific subject items applicable to the client, the client data further comprising authorized user data;
one or more secured, interactive web pages accessible to authorized users for enabling users to access compliance data relating to one or more specific subject items;
a database engine comprising one or more query, sort and find software to generate compliance data for the one or more specific subject items input by user, the compliance data comprising applicable compliance requirements, tasks required, triggers if any, due date for performing one or more required tasks and the responsible person for performing required task; and
one or more report generators to generate one or more compliance reports for specific subject items.

43. The compliance system of claim 42 wherein the reports comprise one or more checklists, one or more compliance tables, one or more equipment query reports, one or more site information reports, one or more equipment lists and one or more inventory reports.

44. The compliance system of claim 43 wherein the checklists comprise substantially each subject item within the facility, one or more compliance tasks required and a verification signature requirement for the responsible person.

45. The compliance system of claim 42 further comprising one or more pre-set tickler systems for each required compliance task to notify the responsible person of the compliance task and its due date.

46. A method for facilitating compliance comprising:
(a) providing a system for facilitating compliance that is accessible on a secured, interactive web site, the web site accessible to multiple computers via network connectivity; the system comprising compliance data and subject items subject to compliance, accessibility to the data limited to authorized users;
(b) providing weather data to authorized users required to comply with storm water sampling regulations according to the compliance data.

47. The compliance method of claim 46 wherein the weather data comprises notification of a specified chance of rain fall and notification of actual rainfall.

48. The compliance method of claim 47 wherein the weather data is sent to authorized users.

49. A method for facilitating compliance comprising:
(a) providing a secured, interactive web site accessible to multiple computer processors;
(b) providing one or more databases comprising compliance data and subject items subject to compliance, accessibility to the one or more databases limited to authorized users;
(c) identifying subject items applicable for a specific authorized user;
(d) determining compliance requirements and tasks necessary to be in compliance for one or more subject items identified in step (c);
(e) providing compliance requirements and tasks as determined in step (d) to a responsible person of the specific authorized user; and
(f) continuing to provide compliance requirements and task notification to responsible persons along the chain of command of the management hierarchy until each requirement and task is completed or the due date has passed.

50. The compliance method of claim 49 further comprising the step of sending a notice of potential non-compliance to a designated authority for any of the one or more tasks not completed by the due date.

51. The compliance method of claim 49 further comprising a checklist of compliance requirement tasks to be ticked off upon completion of each task required for compliance according to the compliance data.

52. The compliance method of claim 51 comprising a software program for automatically providing email reminders of compliance requirements and tasks necessary to be in compliance to a responsible person until the task is ticked off on the checklist.

53. A method for facilitating compliance comprising:
(a) providing a secured, interactive web site hosted by at least one computer server in communication with a computer network, the web site accessible to multiple computer processors, the web site comprising compliance data, rules and required tasks and subject items subject to compliance, accessibility to the compliance data, rules and required tasks limited to authorized users;
(b) notifying a responsible person of an authorized user of the compliance requirement rules and tasks for subject items applicable to authorized user; and
(c) continuing to provide compliance requirement notification to responsible persons along the chain of command of the management hierarchy until the compliance requirement task is ticked off a checklist.

54. A compliance system comprising:
a web site hosted by a server, the web site accessible by multiple computers;
a data structure located on the web site comprising compliance data and required tasks for compliance;
one or more secured, interactive web pages located on the web site accessible to authorized users for enabling users to determine applicable compliance data and tasks;
means for notifying a responsible person of the compliance requirements and tasks required for compliance; and
a checklist for ticking off completed tasks.

55. The system of claim 54 wherein compliance data comprises compliance requirements emanating from one or more laws, statutory codes, government rules and regulations, permit requirements, government standards, industry standards, rules and procedures, company procedures and guidelines, procedures and guidelines of one or more regulatory authorities or combinations thereof.

56. The method of claim 55 wherein the one or more regulatory authorities comprise government legislatures, government agencies, industry associations, and company organizations.

57. The compliance system of claim 54 wherein the means for notifying a responsible person is automated by a computer.

58. The compliance system of claim 54 wherein the means for notifying a responsible person is a manual input program.

59. The compliance system of claim 54 further comprising a management hierarchy list so that the responsible person is selected from the management hierarchy list.

60. The compliance system of claim 54 wherein the checklist comprises substantially each subject item within an authorized facility that is subject to compliance data, one or more required compliance tasks for each item and identification data for the responsible person to perform the one or more required compliance tasks.

61. A compliance system comprising:
a web site hosted by a server accessible by multiple computers;
a data structure located on the web site comprising one or more relational databases, the one or more relational databases comprising compliance data, tasks necessary for compliance, client data, and subject items subject to compliance;
one or more secured, interactive web pages accessible to authorized users for enabling users to access compliance data relating to specific subject items;
a database engine comprising one or more query, sort and find software to generate compliance requirements and necessary tasks for the one or more specific subject items, the compliance requirements comprising due dates for performing tasks and identification data for one or more persons for performing responsible tasks; and
one or more report generators to generate one or more compliance reports for the specific subject items;
means for notifying the one or more responsible persons of the compliance requirements and required tasks; and
a checklist for ticking off completed tasks.

62. The compliance system of claim 61 wherein the subject items comprise facility sites, equipment, materials and activities subject to compliance.

63. The compliance method of claim 61 further comprising means for sending a notice of potential non-compliance to a designated manager for any of the one or more required tasks not completed by the due date.

64. The compliance system of claim 61 further comprising a management hierarchy list so that the responsible person is selected from the management hierarchy list.

65. The compliance system of claim 61 wherein the authorized user is an auditor.

66. A compliance system comprising:
a web site hosted by a server, the web site accessible by multiple computers;
a data structure located on the server comprising compliance data, a summary of compliance rules and tasks required for compliance;
one or more secured, interactive web pages accessible to authorized users for enabling users to determine applicable compliance requirements and required tasks;
means for notifying a responsible person of an authorized user of the compliance requirements and tasks; and
a checklist for ticking off completed tasks required for compliance; and
hyperlinks to a regulatory database comprising full text of compliance rules and required tasks.

67. A compliance system comprising:
a web site hosted by a server, the web site accessible by multiple computers;
a data structure on the server accessible through the web site, the data structure comprising compliance data, a summary of compliance rules and tasks required for compliance;
hyperlinks to a government regulatory database comprising full text of compliance rules and required tasks;
a software program for comparing the summary of compliance rules and tasks to the government regulatory database for updating the rules and tasks; and
one or more secured, interactive web pages located on the web site, the web pages accessible to authorized users for enabling users to determine updated compliance data, rules and required tasks.

68. The compliance system of claim 64 wherein the software program comprises a means for alerting the authorized user to the update of the rules and tasks.

69. The compliance system of claim 65 wherein the means for alerting a responsible person to the update of the rules and tasks is an automated email system.

70. A compliance system comprising:
a web site hosted by a server, the web site accessible by multiple computers;
a data structure located on the web site comprising compliance data, compliance rules and tasks required for compliance;
one or more secured, interactive web pages located on the web site, the web pages accessible to authorized users;
a software program for responding to an unscheduled event requiring one or more compliance tasks.

71. The compliance system of claim 70 wherein the software program comprises compliance data for tracking and reporting the unscheduled event.

72. A method for facilitating compliance comprising:
(a) providing a system for facilitating compliance that is accessible on a secured, interactive web site, the system comprising compliance data and subject items subject to compliance;
(b) identifying specific subject items for a client and compliance requirements for specific subject items;
(c) defining priority levels of triggers based on the specific subject items and compliance requirements;
(d) defining groups of client personnel authorized to receive trigger notification, the groups prioritized according to management hierarchy and priority level of trigger;
(e) sending reminder notices to client personnel based on management hierarchy level and trigger priority level.

73. The method for facilitating compliance of claim 72 wherein the reminder notices are sent by email, fax or telephonic communication.

74. A method for facilitating compliance with environmental rules and regulations comprising:
(a) providing a system for facilitating compliance that is accessible on a secured, interactive web site, the web site accessible to multiple computers via network connectivity, the system comprising compliance data including environmental compliance rules and regulations, required compliance tasks and subject items subject to environmental compliance, accessibility to the system limited to authorized users;
(b) determining the environmental compliance rules and regulations and tasks applicable to specific subject items.
